(19) United States
(12) Patent Application Publication
(10) Pub. No.: US 2012/0305083 A1
(43) Pub. Date: Dec. 6, 2012

(54) Co-extruded oxidation-resistant polyethylene pipe and method of manufacture

(75) Inventors: Michael E. Dahl, Chicago, IL (US); David M. Fink, Keller, TX (US)

(73) Assignee: WLP HOLDING CORPORATION, FORT WORTH, TX (US)

(21) Appl. No.: 13/134,295

(22) Filed: Jun. 4, 2011

(51) Int. Cl. F15D 1/00; B32B 1/06; F16L 9/14

(52) U.S. Cl. 137/1; 138/140; 264/171.12

(57) ABSTRACT

A co-extruded multi-layer plastic pipe and method of manufacture are disclosed in which a first extruder melts and extrudes a first plastic material into the outer annulus of a coaxial extrusion die to form an outer pipe layer, and a second extruder melts and extrudes a highly oxidation-resistant plastic material into the inner annulus of said coaxial extrusion die under a blanket of inert gas to create an inner pipe layer, whereby the outer and inner pipe layers are fused together under the protection of the inert gas blanket which prevents premature degradation of the oxidation-resistant inner layer until the finished extruded pipe has cooled and solidified.

### FIELD OF THE INVENTION

This invention relates to polyethylene (“PE”) pipe as used in water distribution systems. Water distribution systems generally consist of several categories of piping. Transmission pipes generally are larger sizes that transport water from a source such as a well or reservoir to distribution pipes that are more moderately sized mains and sub-mains that distribute water throughout the municipality. Depending on the size of the water system, transmission and distribution pipes may be similarly sized and transmission and distribution pipes may serve the same purpose. Service pipes are smaller size pipes that transport water from the distribution main or sub-main to the user.

When internal pressure is applied to pipe, the pressure causes a circumferential or hoop stress to the pipe wall. Polyethylene pipes for pressure water piping systems are manufactured such that as pipe size varies, the wall thickness varies in accordance with a ratio of wall thickness to diameter so as to maintain an allowable hoop stress for an allowable internal pressure. That is, as diameter varies, wall thickness also varies in accordance with the ratio, and therefore larger pipes will have greater wall thickness than smaller pipes for the same allowable internal pressure.

PE pipe is susceptible to oxidizing agents which, over time, diffuse through the plastic causing oxidative degradation. Such degradation occurs both from chemical reaction with atmospheric oxygen and reaction with oxidizing disinfectant agents such as chlorine (“Cl”) and hypochlorous acid (“HOCl”) which are commonly added to municipal water supplies.

### BACKGROUND OF THE INVENTION

PE pipe is widely used for underground municipal water distribution systems. Such systems commonly introduce purification agents such as chlorine and hypochlorous acid for public health reasons. While it has long been recognized that PE needs to be protected from oxidative degradation from contact with the atmosphere, it is now also well known that chlorine and hypochlorous acid are just as detrimental to PE pipe as are atmospheric oxidizing agents. PE pipe is susceptible to degradation by reaction with free chlorine present in potable water as described in “Chlorine Resistance Testing of Cross-linked Polyethylene Piping Materials” by P. Vibien, et al. of Jana Laboratories Inc., Ontario, Canada, and W. Zhou et al. of University of Illinois at Chicago, Chicago, Ill., U.S.A.

To protect PE against oxidation from atmospheric oxygen, antioxidants are often added. However, it is equally important to protect PE pipe from internal degradation when used in municipal water systems and the like, where chlorine or HOCl are added to the water and which can migrate from the water into the pipe. This migration weakens the pipe and shortens its useful life, making it difficult to assure an acceptable degree of protection from oxidative damage for the design life of the public water system, which can be as much as 50 years.

Conventional antioxidants, which protect PE pipe from atmospheric oxygen, are consumed quickly when the pipe is placed underground for use in municipal water supplies where it is subjected to strong oxidizing agents such as chlorine or HOCl. Simply increasing the amounts of antioxidants in the PE composition is not an acceptable solution because of high cost of antioxidants.

There are two sources of atmospheric oxygen that can cause undesired oxidation reactions with PE pipe. One source, obviously, is atmospheric oxygen external to the pipe's inner and outer surfaces. A second and largely unappreciated source is the atmospheric oxygen which surrounds the polyethylene feed pellets as they enter the throat of the pipe extruder. This second source can become entrained within the extrudate where it is available to provide oxygen for oxidation reactions within the pipe wall.

In the prior art, this problem has been approached in different ways. A single-step process for forming a multilayer cross-linked polyethylene (“PEX”) pipe having at least two layers (twin-layered pipe) is disclosed in Backman, et al. U.S. Pat. No. 7,086,421 where the product is a pipe with a thin annular core of high-density polyethylene (HDPE) which provides improved resistance to attack by oxidation agents such as chlorine and hypochlorous acid, supposedly without significantly decreasing the hoop stress of the multilayered pipe.

Chang et al., US 2004/0222544 discloses a means to minimize the degradation of such polymers in a continuous extrusion process by injecting an inert gas blanket (nitrogen) into the extruder feed hopper. However, this disclosure does not include any suggestion of using a nitrogen blanket for protecting the vulnerable inner core of an extruded multi-layer pipe from oxidation during the extrusion process.

The standard thermoplastic pipe material designation code for polyethylene consists of an abbreviation for the type of plastic followed by 4 numbers that describe its key properties. The abbreviation for polyethylene is PE. The first two numbers are property cell classification values for density and slow crack growth (SCG) resistance in accordance with ASTM D3350. The last two numbers refer to the hydrostatic design stress (HDS) for the polyethylene material in units of 100 psi with tens and units dropped.

| PE | Abbreviation for polyethylene |
|---|---|
| 4 | Density cell classification 4 per D3350 |
| | (>0.947-0.955 g/cc) |
| 7 | SCG cell classification 7 per D3350, |
| | (ASTM F1473 (PENT) value >500 hours) |
| 10 | 1000 psi hydrostatic design stress for |
| | water at 73° as listed in PPI TR-4 per |
| | PPI TR-3, Section F.7 |

In the chart above the designation “PE 4710” identifies the piping material as polyethylene with a density cell classification of 4, a “slow crack growth” cell class of 7 (both in accordance with ASTM D3350), and a 1000 psi hydrostatic design stress rating for water at 73° F. as recommended by the Plastics Pipe Institute (PPI) in PPI Technical Report TR-4. PE having a density cell classification of 3 or 4 is also known as HDPE, high density polyethylene. PE having a density cell classification of 2 is also known as MDPE, medium density polyethylene. PE having a density cell classification of 1 is also known as LDPE, low density polyethylene.

### SUMMARY OF THE INVENTION

It is a principal object of the invention to provide a method and apparatus for producing, by co-extrusion, a twin-layer PE pipe having excellent strength and resistance to UV degradation on its outer surface, while having improved resistance to attack by oxidation agents such as chlorine and hypochlorous acid on its inner surface.

A further object of the invention is to provide such a method which minimizes the amount of antioxidants utilized in the manufacturing process by providing an inert gas blanket to the inner coextruded layer of the pipe during and immediately after extrusion, thereby preventing atmospheric oxygen from attacking the inner layer when it is molten and therefore most vulnerable.

A further optional object of the invention is to provide such a method which minimizes the amount of antioxidants utilized in the manufacturing process by providing an inert gas blanket to the outer coextruded layer of the pipe during and immediately after extrusion, thereby preventing atmospheric oxygen from attacking the outer layer when it is molten and therefore most vulnerable.

A related object is to provide a multi-layer pipe for use in below-ground municipal water distribution systems, which is strong, inexpensive and long-lived.

A further object of the invention is to provide a UV-resistant and oxidation-resistant PE outer layer of UV-resistant and oxidation-resistant PE4710, or of UV-resistant and oxidation-resistant HDPE, or of UV-resistant and oxidation-resistant MDPE.

A still further object of the invention is to provide a UV-resistant and oxidation resistant PE inner layer of oxidation-resistant PE4710, or of oxidation-resistant HDPE, or of oxidation-resistant MDPE.

Moreover, the principal object of the invention may be met by any of the combinations of the outer layer and inner layer PE materials depicted in the following chart.

| | UV-Resistant and Oxidation- | | | | | |
|---|---|---|---|---|---|---|
| | Resistant Outer Layer | | | | | |
| Layer | Material | | | | | |
| Combination | PE4710 | HDPE | MDPE | PE4710 | HDPE | MDPE |
| 1^{st} | X | | | X | | |
| 2^{nd} | X | | | | X | |
| 3^{rd} | X | | | | | X |
| 4^{th} | | X | | X | | |
| 5^{th} | | X | | | X | |
| 6^{th} | | X | | | | X |
| 7^{th} | | | X | X | | |
| 8^{th} | | | X | | X | |
| 9^{th} | | | X | | | X |

The foregoing and additional objects of the invention will best be understood by reference to the following drawings and detailed description.

### BRIEF DESCRIPTION OF THE DRAWINGS

FIG. 1 is a schematic representation of dual-feed extrusion die in which the principal feed of strong, UV-resistant and oxidation-resistant PE is directed into the outside annulus of an extrusion die to form the outside extruded layer of a two-layer pipe having, and the secondary feed of additive-rich oxidation-resistant PE is directed into an inner annulus to form a relatively thin inner tubular core extruded layer.

FIG. 2 is a cross-sectional view (not to scale) of a double-layer pipe made according to the invention and having an outer layer of UV-resistant and oxidation-resistant PE and a relatively thin inner co-extruded tubular core of oxidation-resistant PE, such as HDPE, incorporating one or more of several commercially available anti-oxidant additives.

FIG. 3 is a representative extrusion die capable of receiving the output of the screw extruders and directing it into concentric annuli to form the two-layer pipe of FIG. 2.

### DETAILED DESCRIPTION OF THE PREFERRED EMBODIMENT

The invention will be better understood by referring to the drawings.

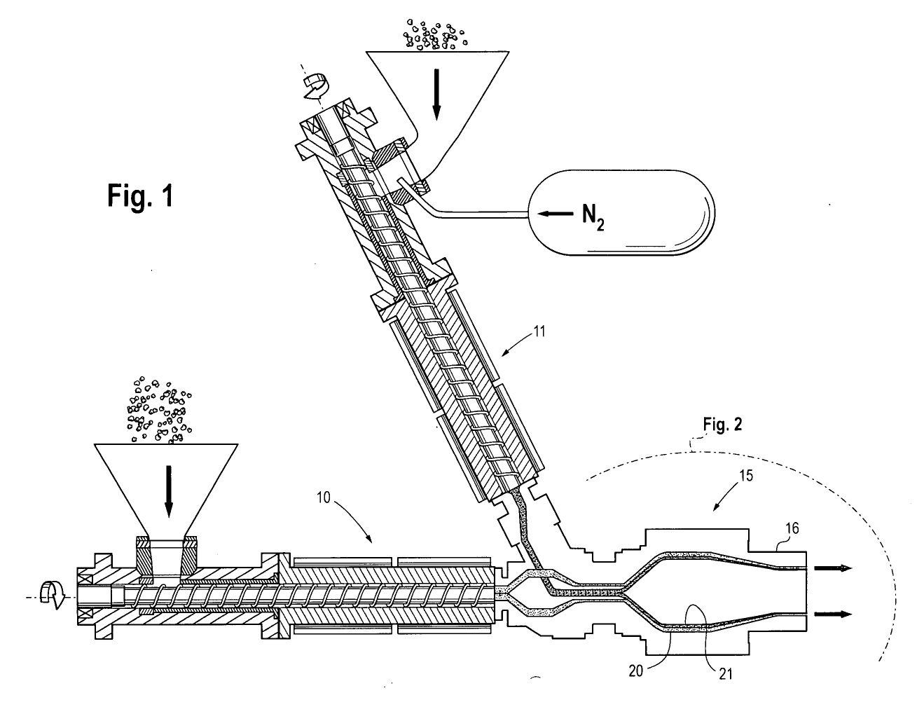

FIG. 1 shows a schematic representation of an extruder line including a primary extruder 10 for the outer layer of strong, UV-resistant and oxidation-resistant PE, and a secondary extruder 11 providing a secondary feed of additive-rich oxidation-resistant PE which forms a relatively thinner inner tubular core layer.

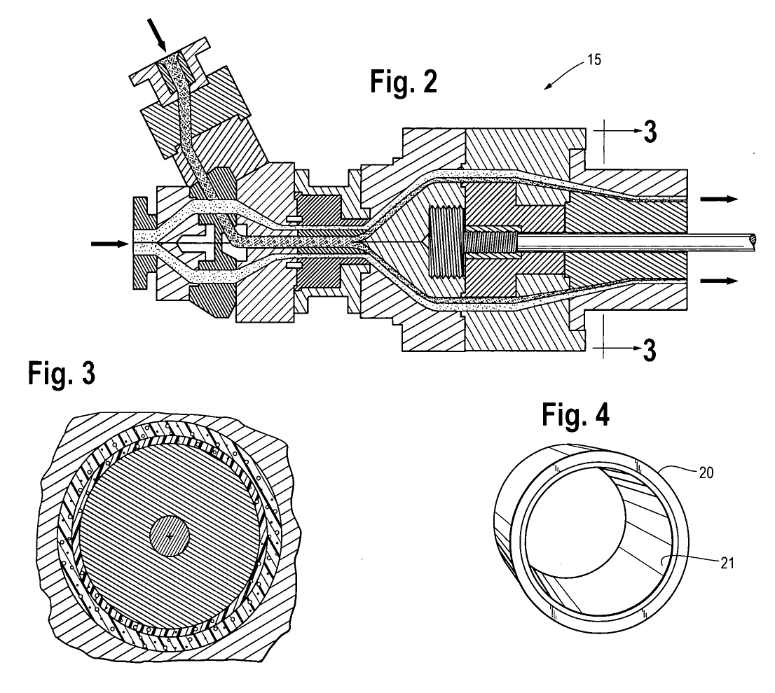

FIG. 2 shows a cross-section of the completed two-layer pipe 12 (not to scale) in which the process of the present invention has been utilized to create a finished pipe in which a strong UV-resistant and oxidation-resistant outer layer 13 is bonded to a relatively thinner oxidation-resistant inner core 14.

FIG. 3 shows a representative extrusion die 15 capable of receiving the output of the screw extruders and directing it into concentric annuli to form the two-layer pipe 12 of FIG. 2. The overall dimensions of the multi-layer pipe are chosen to meet the specifications set for its use in a specific environment. The thickness of the core is selected to be sufficient to negate oxidative degradation of the PE outer layer by oxidizing agents commonly found in potable water.

To produce the multilayer pipe of this invention, two or more screw-type extruders are used one extruder for each material or layer in the pipe. For a double-layer pipe, two extruders are used as shown in FIG. 1; for a tri-layer pipe, three extruders are used (not shown). The extruders are typically displaced from each other at a displacement angle that is conducive to the principal and secondary feeds from the principal and secondary extruders. The plural extruders feed into a multi-layer pipe die head 15 (FIG. 3) such as is commercially available from Rollepaal B.V., Netherlands.

The temperature of each successive zone along the longitudinal axial length of the extruders is controlled so as to gradually heat the PE and cause it to melt and flow evenly into the die 15. In the illustrated embodiment, the first principal extruder 10 flows UV-resistant and oxidation-resistant PE into a first inlet port in the die head 15, while the secondary extruder 11 flows additive-rich PE into a second inlet port.

To retain its cylindrical shape and predetermined size, the double-layer pipe of the illustrated embodiment is passed through chambers (not shown) that simultaneously size and cool the pipe.

From the first and second inlet ports the molten PE flows through distribution passages in the die head 15 into an inner annular zone, and then over a frusto-conical forming mandrel, and finally through a sizing orifice 16. When the tubular inner core of PE contacts the inner surface of the outer layer being formed, a double-layer tubular laminate is formed in which the two layers are melt-bonded cohesively together such that no adhesive is required. The formed double-layer pipe is then drawn by a drawing mechanism (not shown) that pulls the formed pipe away from the extruder and into sizing and cooling chambers. The finished pipe, when cool, is then cut to desired lengths by a cut-off saw (not shown).

According to the invention, the inner layer of the two-layered pipe is produced from an oxidation-resistant PE compound such as Dowlex® 2344 (The Dow Chemical Company) with additional antioxidants (or combination of antioxidants) such as Irganox® 1330, 1010 or 1076 (Ciba Specialty Chemicals Corporation), or a PE compound that contains an antioxidant package similar to the above which is incorporated into the feed material for the inner PE layer.

If desired, the feedstock for the inner core layer may include other additives to make it light-reflective, such as titanium dioxide, to facilitate optical inspection of the finished pipe in service by robotic means. According to this aspect of the invention, a colorant such as titanium dioxide may be added to make the interior of the inner layer light-reflective, thereby making it more amenable to visual inspection by automated means such as video cameras carried by remote-controlled pipe-crawling robots.

As a principal feature of the invention, a continuous flow of inert gas, preferably nitrogen, is introduced into an opening 17 at the base of the additive-rich PE supply hopper 18 via a supply tube 19. The nitrogen serves to blanket the material issuing from the co-extruder into the die to form the inner layer of the finished pipe. Introducing an inert gas (nitrogen or other inert gas) at the extruder feed throat displaces the oxygen-containing air surrounding the PE pellets as they enter the extruder, thereby reducing the level of entrained oxygen in the extrudate and thus in the pipe wall, as well as reducing the amount of entrained oxygen available for intra-wall oxidation reactions.

The thinner inner layer 14, which contains the relatively more expensive anti-oxidant, is blanketed with nitrogen, thereby preventing premature exhaustion of its anti-oxidant properties due to contact with atmospheric oxygen during and immediately after extrusion, when the product is hot and vulnerable to oxidation. The nitrogen blanket remains with the product as it continues to cool, after which it is permitted to escape to the atmosphere.

Depending on the size of the pipe and the pipe wall thickness, the outer layer 13 (the primary pipe wall) does not need to be heavily loaded with anti-oxidant. However, it is preferable that smaller size pipes (typically service sizes and small distribution sub-mains) be blanketed with inert gas to preserve the anti-oxidant level. Larger size distribution and transmission pipes having greater wall thickness do not need to be blanketed with inert gas because larger pipes have greater material thickness to resist oxidative damage.

### EXAMPLES

A two-inch DR11 (ratio of pipe diameter to minimum wall thickness=11) double-layer layer pipe was made by co-extruding an outer layer of PE4710 PE material with and an inner layer of Dowlex® 2344 PE-RT copolymer material (polyethylene of raised temperature resistance) to which was added 1000 ppm each of Irganox 1330, 1010 and 1076.

A second run of two-inch DR11 pipe was made by co-extruding an outer layer of PE4710 PE material with and an inner layer of anti-oxidant enriched PE4710 containing to which was added 2000 ppm each of Irganox 1330, 1010 and 1076.

A third run of two-inch DR11 pipe was made for control purposes by extruding a solid-wall pipe of PE4710 PE material having no inner oxidation-resistant wall.

The pipe in each run was extruded at 16 ft/min (600 lbs/hr) with a nitrogen blanket feed of 20 cu.ft. per hour. The resulting total wall thickness (inner and outer layers combined) varied between 0.216-0.230 in. Excepting the third run, the inner layer of each run averaged about 0.015 in. thick.

The finished pipe from each run was cooled and then cut into ten-inch sample sections. The sample sections were tested and analyzed for resistance to chlorine exposure by Jana Laboratories Inc. of Aurora, Ontario using the test conditions prescribed in ASTM F2263-07e1, Standard Test Method for Evaluating the Oxidative Resistance of Polyethylene (PE) Pipe to Chlorinated Water.

The three specimens were butt fused to form a single piece, which was provided with suitable fittings and exposed to a controlled environment of pressurized, flowing chlorinated water at elevated temperature (176° F./80° C.) for exposure times of zero, 100, 300 and 500 hours. The specimens were then tested for the relative levels of stabilizer remaining (Oxidation Induction Time, or OIT) and relative level of oxidation by measuring carbonyl ration (FTIR). The samples were also subjected to bend-back testing to determine onset of inner surface micro-cracking.

In all three samples, no signs of oxidative degradation were observed on the as-extruded samples. High OIT values were observed for all samples, but the co-extruded two-layer samples exhibited high OIT values (172 and 181 minutes), almost double that of the solid-wall control sample (94 minutes)

The retention of OIT values with exposure time was markedly improved with the co-extruded samples With 300 hours of chlorine exposure, the inner surface of the solid-wall sample retained only 1% of its initial value, suggesting nearly complete depletion of stabilizers from its inner surface.

By contrast, the inner surfaces of both co-extruded two-layer samples retained significant amounts of stabilizer even after 500 hours of exposure. The PE4710 inner layer sample after 100 hours of exposure had an OIT value similar to that of the unexposed solid-wall sample, while the PE-RT sample exhibited similar properties after 300 hours of exposure.

In bend-back testing, the solid wall control sample was observed to have inner surface crazing after 300 hours of exposure, from which more micro-cracking developed after 500 hours. By contrast, neither crazing nor micro-cracking were observed for the co-extruded samples after 500 hours of exposure.

Buy way of conclusion, Jana Laboratories noted that the inner layers of the co-extruded samples were markedly effective in delaying oxidative degradation, with the time for onset being at least double that of the solid-wall control sample.

1. A method of making a co-extruded multilayer plastic pipe with an extruder having first means for melting and extruding an outer layer of plastic pipe and second means for simultaneously melting and extruding an inner layer coaxial with said outer layer, comprising the steps of:
(a) simultaneously melting and co-extruding said outer and inner layers in intimate contact through a common die, while injecting a blanket of inert gas within said inner layer; and
(b) allowing said outer and inner layers to cool and solidify in the presence of said inert gas.

2. A co-extruded multi-layer plastic pipe made according to claim 1, wherein each of the outer and inner layers has a thickness, and the ratio of the thickness of the outer layer to the inner layer is between about 10 and 100.

3. A method of use comprising
(a) providing a plurality of multilayer plastic pipes each according to claim 2;
(b) deploying said plurality of multilayer plastic pipes underground for conveying chlorine-treated potable water; and
(c) distributing chlorine-treated potable water through said plurality of multilayer plastic pipes.
